(19) United States
(12) Patent Application Publication
(10) Pub. No.: US 2019/0336252 A1
(43) Pub. Date: Nov. 7, 2019

(54) Expandable Dental Impression Tray

(71) Applicant: Thamer Marghalani, Jeddah (SA)

(72) Inventor: Thamer Marghalani, Jeddah (SA)

(21) Appl. No.: 15/969,658

(22) Filed: May 2, 2018

(51) Int. Cl. A61C 9/00

(52) U.S. Cl. CPC A61C 9/0006

(57) ABSTRACT

An expandable dental tray apparatus and method are provided, the apparatus having a center section and two side sections interconnected by deformation zones or hinges. The apparatus in a retracted configuration may be inserted into a mouth, then adjusted into one or more expanded configurations. Locking mechanisms maintain the dental tray in the desired expanded configuration. The side sections may be easily replaced with alternatively sized side sections prior to use.

### STATEMENT REGARDING FEDERALLY SPONSORED RESEARCH AND DEVELOPMENT

Not Applicable.

### BACKGROUND OF DISCLOSURE

### 1. Field of Invention

The present invention generally relates to devices for dental impressions, and more specifically to an expandable dental impression tray apparatus and method.

### 2. Description of the Prior Art

Several dental impression trays are commonly used to acquire impressions for upper and lower teeth; however, many dental impression tray inventions in the prior art are limited and do not address difficulties that arise when inserting the impressions into a mouth. U.S. Pat. No. 1,486,039 patent to Santos discloses a dental impression tray having a base plate with an extension at one end, side sections pivotally connected to the base plate and having extensions at adjacent ends projecting outwardly, and a front section superimposed upon the base plate extension and capable of longitudinal movement with respect to the plate. U.S. Pat. No. 2,426,388 patent to Chartrand discloses a dental impression tray having a substantially Y-shaped frame with a simple rigid handle and two relatively adjustable angularly arranged arms with a substantially U-shaped channel pivotally secured to the arms of the frame. U.S. Pat. No. 7,125,251 patent to Livolsi discloses an adjustable impression tray with variable geometry comprising a gutter and at least one integrated deformable zone having a multidirectional extension portion.

Devices such as these do not address how to make adjustments to the molar teeth regions of the mouth without insertion of a hand deep into the mouth or other actions that promote discomfort. The present invention overcomes this, and other concerns, by providing an impression tray that utilizes three sections interconnected by an expanding means to enable a user to easily adjust the size of the tray and the directions of the right and left compartments in order to accommodate a variety of mouth sizes and mandibular restrictions.

### SUMMARY OF THE DISCLOSURE

The present invention provides an apparatus and a convenient method for effectively taking dental impressions for various mouth sizes and for mouths with restricted mandibular movements. In a preferred embodiment, the apparatus for the lower jaw (mandible) comprises a center section and two side sections, the center section having a handle protruding from the bottom surface of the tray, a central base plate, a central outer wall, and a central inner wall, the side sections each having a side base plate, a side outer wall, and a side inner wall. An expanding means, which may be in the form of hinges or a deformation zone, interconnects the center section to the two side sections and allow rotation of each side section about the corresponding hinge or deformation zone. Each side section has a proximal end portion that curves towards the longitudinal centerplane, and a distal end portion that is substantially straight. The apparatus for the upper jaw (maxilla) further comprises a central inner plate and a side inner plate.

In an embodiment, the center section further comprises a handle centered about the longitudinal centerplane extending exteriorly from the central base plate proximate to the central outer wall. In an embodiment, the central outer wall or at least one of the side outer walls further comprise a top lip for securing impression material. In an embodiment, each of the side base plates comprises a protrusion on the underside, or bottom, for adjusting orientation of each of the side base plates relative to the center section.

In an embodiment, the central base plate extends substantially equivalent to or extends further between the central outer wall and the central inner wall at the central end portions than at the longitudinal centerplane. In an embodiment, each of the two side sections comprise a beveled, chamfered, rounded or oval cross-sectional profile for accommodating an edentulous dental arch.

In an embodiment, the dental impression tray further comprises a locking mechanism, which may be releasably detachable for allowing dental impression tray reusability. In an embodiment, the locking mechanism may take the form of a simple clip and latch, a clip and a multi-step latch, a concavity and ball on opposing contacting surfaces, or a locking strip and a plurality of serrations. In an embodiment, at least one of the locking mechanisms is positioned exteriorly on one of the side inner walls and the central inner wall.

In an embodiment, each part of the impression tray is reversibly detachable, including but not limited to deformation zones, hinges, and side sections. In an embodiment, the center section or the two side sections are replaceable with wide, medium, or narrow widths for accommodating a variety of dental arch sizes and configurations. In an embodiment, the center section or the two side sections are replaceable with high, normal, or low heights for accommodating a plurality of facial dental sulcus depths and configurations. In an embodiment, the two side sections are replaceable with long, normal, or short lengths for accomodating a variety of dental arch sizes and configurations.

Embodiments include one, more, or any combination of all of the features listed above. Other features and advantages of the present invention will become apparent from the following more detailed description, taken in conjunction with the accompanying, which illustrate, by way of example, the principles of the invention.

### DESCRIPTION OF THE DRAWINGS

FIG. 1A is an elevated perspective view of a center section of a dental impression tray for the lower jaw of a mouth, FIG. 1B is an elevated perspective view of a side section of a dental impression tray for the lower jaw of a mouth, and FIG. 1C is an elevated perspective view of a side section of a dental impression tray for the lower jaw of a mouth, in accordance with an exemplary embodiment of the present invention;

FIG. 2A is an elevated perspective view of a center section of a dental impression tray for the upper jaw of a mouth, FIG. 2B is an elevated perspective view of a side section of a dental impression tray for the upper jaw of a mouth, and FIG. 2C is an elevated perspective view of a side section of a dental impression tray for the upper jaw of a mouth, in accordance with an exemplary embodiment of the present invention;

FIG. 3A is a top view of a dental impression tray having deformation zones and in a retracted configuration, in accordance with an exemplary embodiment of the present invention;

FIG. 3B is a top view of a dental impression tray having deformation zones and in a first expanded configuration, in accordance with an exemplary embodiment of the present invention;

FIG. 3C is a top view of a dental impression tray having deformation zones and in a second expanded configuration, in accordance with an exemplary embodiment of the present invention;

FIG. 4 is a bottom view of a dental impression tray showing protrusions, in accordance with an exemplary embodiment of the present invention;

FIG. 5A is a right side view of the dental impression tray shown in FIG. 3B with the locking mechanisms positioned exteriorly on the sides, in accordance with an exemplary embodiment of the present invention;

FIG. 5B is a right side view of a dental impression tray with the locking mechanisms positioned exteriorly on the bottom, in accordance with an exemplary embodiment of the present invention;

FIG. 6A is a top view of a hinged dental impression tray in a retracted configuration, in accordance with an exemplary embodiment of the present invention;

FIG. 6B is a top view of a hinged dental impression tray in a first expanded configuration, in accordance with an exemplary embodiment of the present invention;

FIG. 6C is a top view of a hinged dental impression tray in a second expanded configuration, in accordance with an exemplary embodiment of the present invention;

FIG. 7 is a bottom view of the center section in FIG. 2A showing serrations arranged along the central inner plate, in accordance with an exemplary embodiment of the present invention;

FIG. 8A is a front sectional view of a locking mechanism in an unlocked configuration and having a locking strip and a plurality of serrations, in accordance with an exemplary embodiment of the present invention;

FIG. 8B is a front sectional view of a locking mechanism in a locked configuration and having a locking strip and a plurality of serrations, in accordance with an exemplary embodiment of the present invention;

FIG. 9A is a cross-sectional profile of an angled side section, in accordance with an exemplary embodiment of the present invention; and

FIG. 9B is a cross-sectional profile of a rounded side section, in accordance with an exemplary embodiment of the present invention.

### REFERENCE NUMERALS IN THE DRAWINGS

center section 10
handle 11
central base plate 12
central outer wall 13
central inner wall 14
central inner plate 15
side section 20a, 20b
side base plate 22a, 22b
side outer wall 23a, 23b
side inner wall 24a, 24b
side inner plate 25a, 25b
deformation zone 27a, 27b
protrusion 40a, 40b
top lip 41
central end portions 42a, 42b
side proximal end portion 43a, 43b
side distal end portion 44a, 44b
hinge 50a, 50b
locking mechanism 60a, 60b
clip 61
latch 62a, 62b
locking strip 63a, 63b
serration 64
gap 65
longitudinal centerplane 100

### DETAILED DESCRIPTION OF THE DISCLOSED EMBODIMENT

Illustrative embodiments of the invention are described below in the accompanying Figures. The following detailed description provides detailed schematics for a thorough understanding of and an enabling description for these embodiments. One having ordinary skill in the art will understand that the invention may be practiced without certain details. In other instances, well-known structures and functions have not been shown or described in detail to avoid unnecessarily obscuring the description of the embodiments.

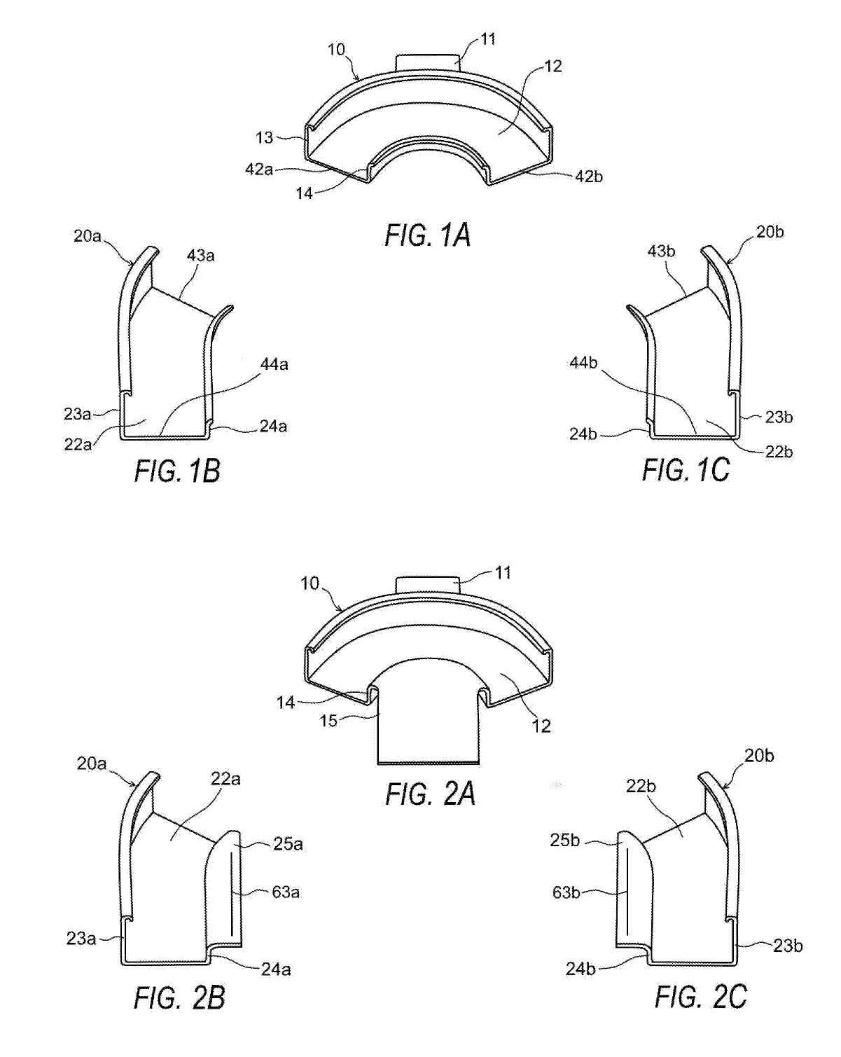

FIG. 1A is an elevated perspective view of a center section 10 of a dental impression tray for the lower jaw of a mouth, FIG. 1B is an elevated perspective view of a side section 20a of a dental impression tray for the lower jaw of a mouth, and FIG. 1C is an elevated perspective view of a side section 20b of a dental impression tray for the lower jaw of a mouth, in accordance with an exemplary embodiment of the present invention. The center section 10 comprises a handle 11, and the combination of a central base plate 12, a central outer wall 13, and a central inner wall 14 forming a channel and concavely curved away from the handle 11 and terminating at central end portions 42a, 42b. The side sections 20a, 20b each comprise the combination of a side base plate 22a, 22b, a side outer wall 23a, 23b, and a side inner wall 24a, 24b forming a channel and each curvedly extending from a side proximal end portion 43a, 43b towards a more substantially straight side distal end portion 44a, 44b. The central outer wall 13 and side outer walls 23a, 23b may further comprise a top lip 41 for securing the impression material in place during use and preventing the impression material from leaving the dental impression tray. The central base plate 12 may either extend substantially equivalently or extend further between the central outer wall 13 and central inner wall 14 at the central end portions 42a, 42b than in between the central end portions 42a, 42b. The central base plate 12 and side base plates 22a, 22b may have numerous pores or holes so that the impression material may pass through upon biting.

FIG. 2A is an elevated perspective view of a center section 10 of a dental impression tray for the upper jaw of a mouth, FIG. 2B is an elevated perspective view of a side section 20a of a dental impression tray for the upper jaw of a mouth, and FIG. 2C is an elevated perspective view of a side section 20b of a dental impression tray for the upper jaw of a mouth, in accordance with an exemplary embodiment of the present invention. The center section 10 of the maxillary dental impression tray further comprises a central inner plate 15 extending from the central inner wall 13 away from the handle 11 and substantially parallel with the central base plate 12. Likewise, each side section 20a, 20b of the maxillary dental impression tray further comprises a side inner plate 25a, 25b extending from a side inner wall 24a, 24b away from the side outer wall 23a, 23b and oriented substantially parallel with the side base plate 22a, 22b. In an embodiment, the side sections 20a, 20b may also comprise locking strips 63a, 63b arranged substantially parallel with the edges of the side inner plates 25a, 25b.

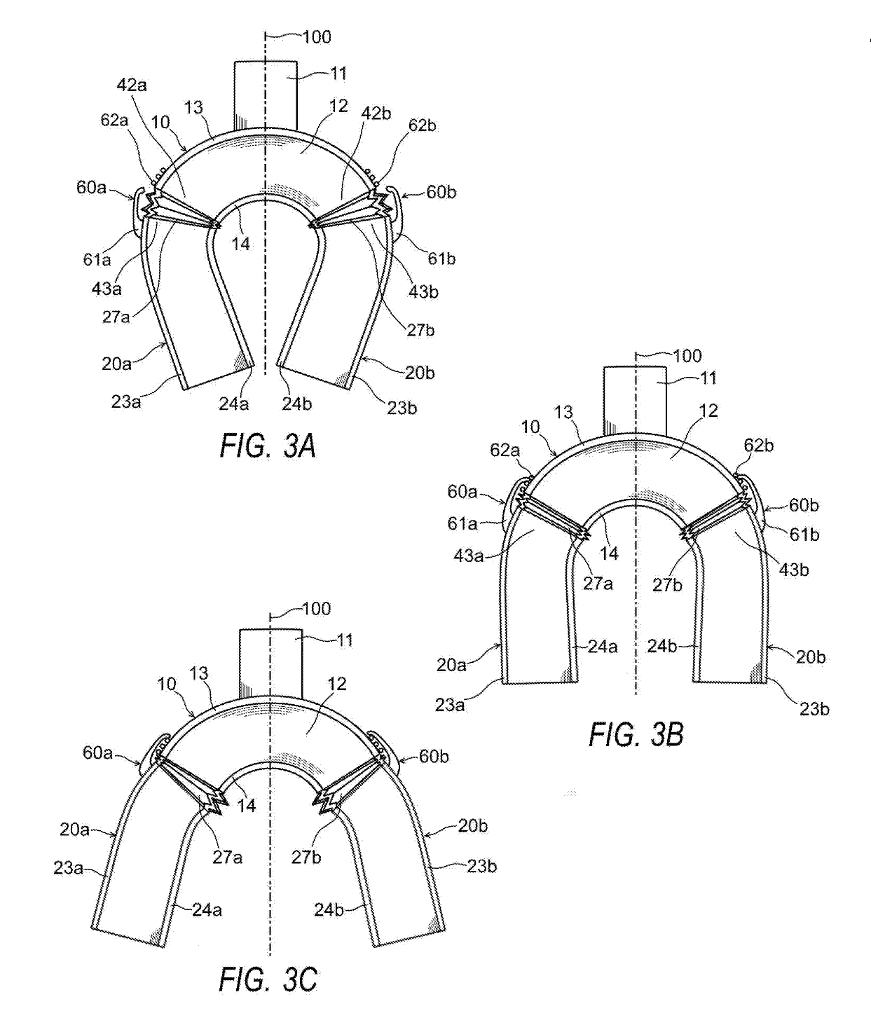

FIG. 3A is a top view of a dental impression tray having deformation zones and in a retracted configuration, in accordance with an exemplary embodiment of the present invention. FIG. 3B is a top view of a dental impression tray having deformation zones and in a first expanded configuration, in accordance with an exemplary embodiment of the present invention. FIG. 3C is a top view of a dental impression tray having deformation zones and in a second expanded configuration. The handle 11 is centered about the longitudinal centerplane 100 and extends exteriorly from the central base plate 12 proximate to the central outer wall 13. In this example embodiment, the center section 10 interconnects with the side sections 20a, 20b via deformation zones 27a, 27b. The deformation zones 27a, 27b are comprised of a flexible polymeric material suitable for cold sterilization and generally take the form of accordion-like flexible zones. The deformation zones 27a, 27b fasten to the center section 10 and side sections 20a, 20b generally by an indention and groove engagement. In this example embodiment, the locking mechanism 60a, 60b takes the form of the combination of a clip 61a, 61b positioned on the exterior surface of the side outer walls 23a, 23b proximate to side proximal end portions 43a, 43b and a group of three latches 62a, 62b positioned on the exterior surface of the central outer wall 13 proximate to central end portions 42a, 42b. In an embodiment, the latch 62a, 62b is a multi-step locking latch that reversibly locks in place the position and orientation of the side sections 20a, 20b relative to the center section 10 at pre-selected extents of expansion for accommodating a variety of dental arch sizes and configurations. In an embodiment, the locking mechanism 60a, 60b is reversibly detachable for promoting reusability.

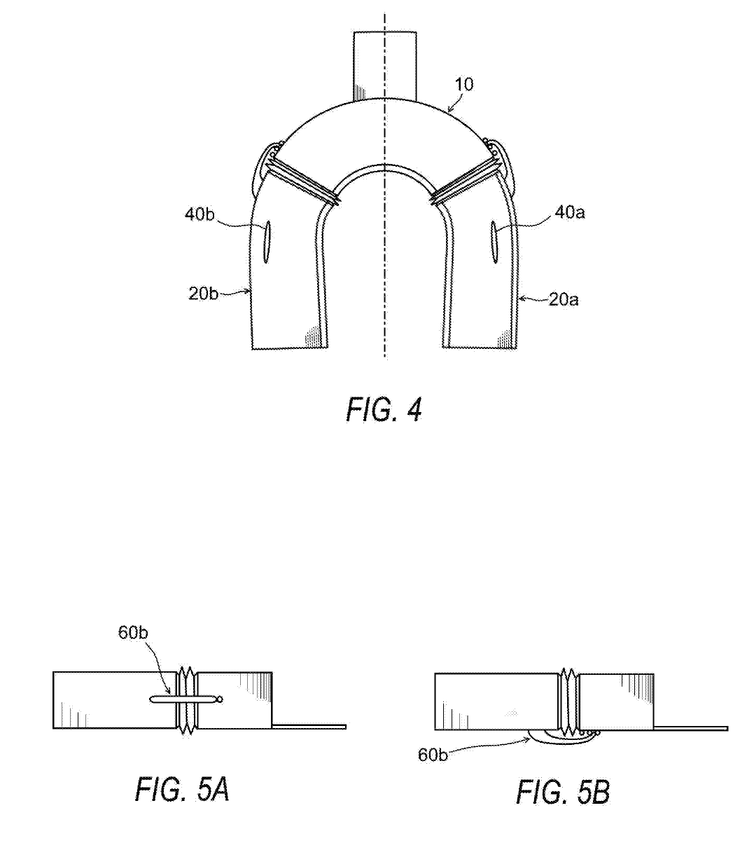

FIG. 4 is a bottom view of a dental impression tray showing protrusions 40a, 40b, in accordance with an exemplary embodiment of the present invention. The protrusions 40a, 40b, which may be bumps or smoothened ridges, are directly fastened to the underside of the side sections 20a, 20b and can be utilized by a user to expand the dental impression tray between a retracted configuration and one or more expanded configurations.

FIG. 5A is a right side view of the locking mechanism 60b shown in FIG. 3B with the locking mechanisms 60a, 60b positioned exteriorly on the sides, in accordance with an exemplary embodiment of the present invention. FIG. 5B is a right side view of a dental impression tray with the locking mechanisms 60a, 60b positioned exteriorly on the bottom, in accordance with an exemplary embodiment of the present invention. In an embodiment, at least one of the locking mechanisms 60a, 60b is positioned exteriorly on one of the side inner walls 24a, 24b to reversibly lock with the center section 10.

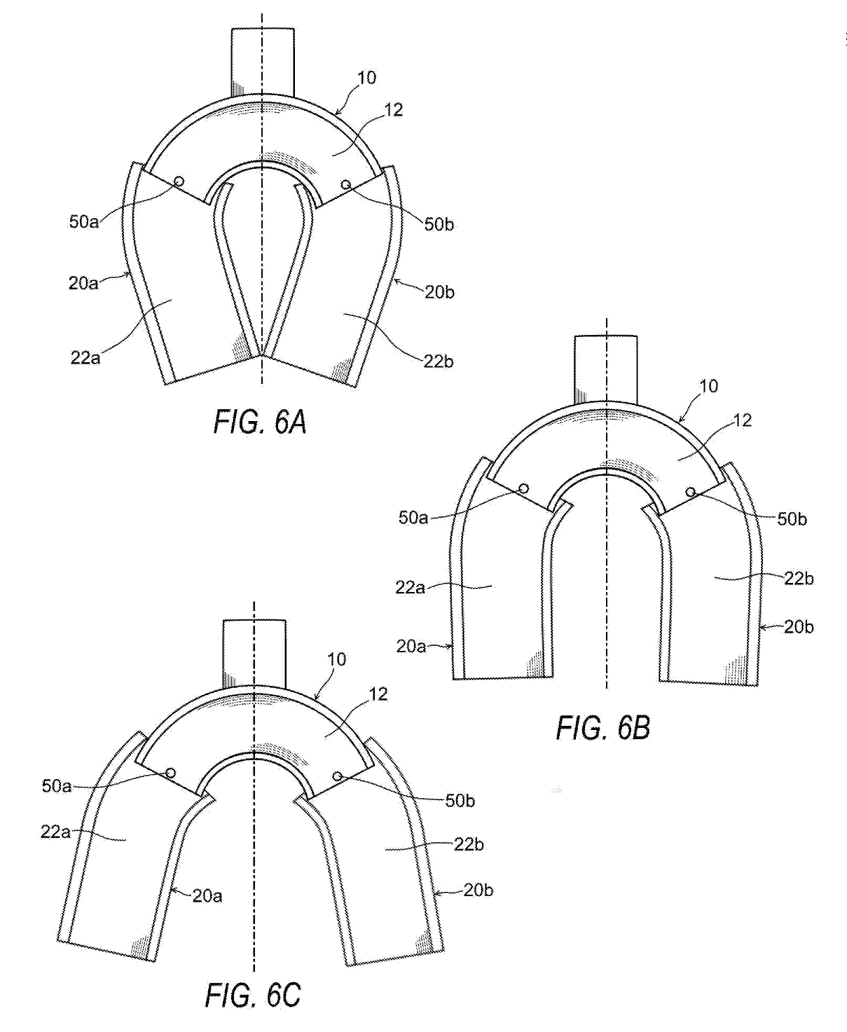

FIG. 6A is a top view of a hinged dental impression tray in a retracted configuration, in accordance with an exemplary embodiment of the present invention. FIG. 6B is a top view of a hinged dental impression tray in a first expanded configuration, in accordance with an exemplary embodiment of the present invention. FIG. 6C is a top view of a hinged dental impression tray in a second expanded configuration, in accordance with an exemplary embodiment of the present invention. In this example embodiment, hinges 50a, 50b interconnect the center section 10 to the two side sections 20a, 20b and allow rotation of each side section 20a, 20b about the corresponding hinge 50a, 50b. The two side sections 20a, 20b may exteriorly surround the center section 10 or may be interiorly surrounded by the center section 10 where overlapped; that is, the side base plates 22a, 22b may slide under or over the center base plate 12 while expanding from a first configuration to a second configuration for preventing leakage of impression material.

In an embodiment for a hinged dental impression tray, at least one of the locking mechanisms 60a, 60b is positioned between the contacting surfaces of the side base plates 22a, 22b and the center base plate 12 (not shown). In this embodiment, the locking mechanism 60a, 60b may take the form of a one or more concavities on one contacting surface and a ball on the other contacting surface.

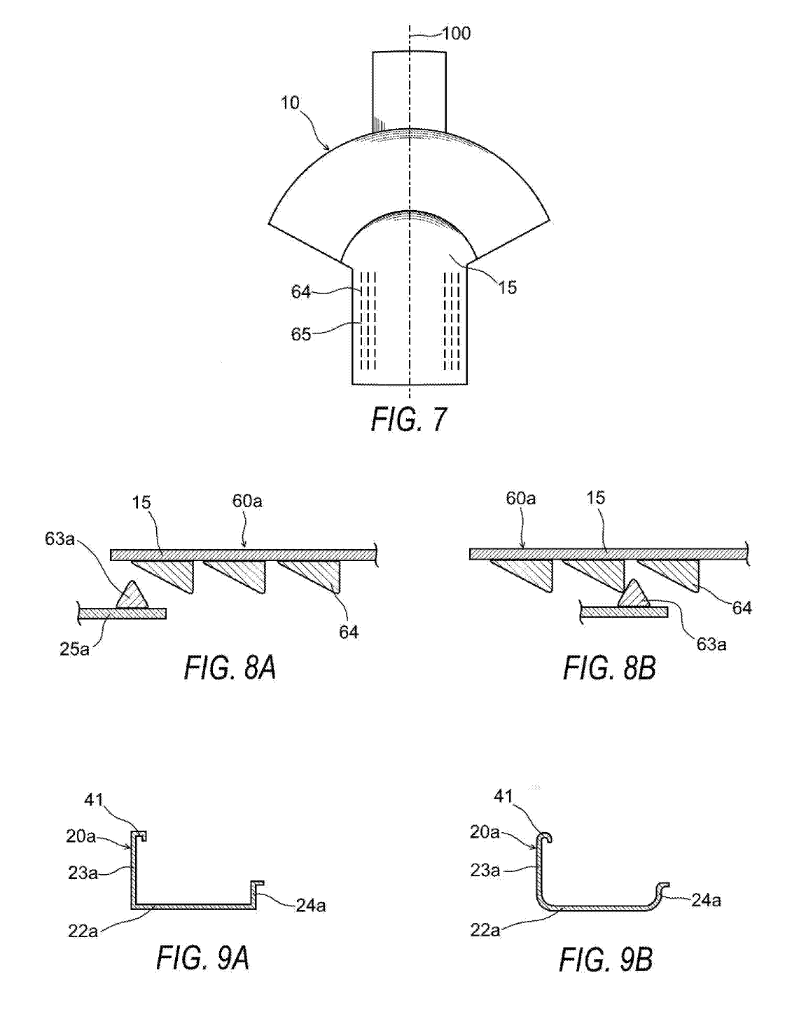

FIG. 7 is a bottom view of the center section 10 in FIG. 2A showing serrations 64 arranged along the central inner plate 15, in accordance with an exemplary embodiment of the present invention. The serrations 64, or ridges, are generally arranged parallel with respect to the longitudinal centerplane 100 and have gaps 65 continuously spaced between the serrations 64. The gaps 65 allow the locking strips 63a, 63b located on the side inner sections 25a, 25b of the side sections 20a, 20b to engage with serrations 64 at various positions on the central inner plate 15.

FIG. 8A is a front sectional view of a locking mechanism 60a in an unlocked configuration and having a locking strip 63a and a plurality of serrations 64, in accordance with an exemplary embodiment of the present invention. FIG. 8B is a front sectional view of a locking mechanism 60a in a locked configuration and having a locking strip 63a and a plurality of serrations 64, in accordance with an exemplary embodiment of the present invention.

FIG. 9A is a cross-sectional profile of an angled side section 20a, 20b, in accordance with an exemplary embodiment of the present invention. FIG. 9B is a cross-sectional profile of a rounded side section 20a, in accordance with an exemplary embodiment of the present invention. In this example embodiment, the rounded nature of the side sections 20a, 20b accommodate an edentulous dental arch, as in cases when a user has no teeth; however, the cross-sectional profile may be beveled, chamfered, or oval without deviating from the scope of this embodiment.

In an embodiment, each part of the impression tray is reversibly detachable, including but not limited to deformation zones 27a, 27b, hinges 50a, 50b, and side sections 20a, 20b. This embodiment promotes reusability and makes washing or cleaning of the individual components less tedious.

One of the many advantages of the present invention over the prior art is the ability for a user to easily replace the side sections 20a, 20b with alternative side sections having alternative lengths, alternative widths, or alternative heights for accommodating a variety of dental arch sizes, facial dental sulcus depths, and dental configurations. In this embodiment, length refers to the average arc distance between a side distal end portion 44a, 44b and the corresponding side proximal end portion 43a, 43b, width refers to the distance between side outer wall 23a, 23b and the corresponding side inner wall 24a, 24b, and height refers to the distance between a side base plate 22a, 22b and top lip 41.

The method for using the three section dental impression tray embodied herein generally comprises the steps of applying a molding material to the central base plate 12 and side base plates 22a, 22b, inserting the dental impression tray with side sections 20a, 20b first into a mouth in a first configuration, adjusting the position of the dental impression tray and the angle of each side sections 20a, 20b relative to the center section via protrusions 40a, 40b, applying pressure to the dental impression tray in the direction of the teeth to be profiled, and removing the dental impression tray from the mouth.

While particular embodiments of the invention have been described and disclosed in the present application, it is clear that any number of permutations, modifications, or embodiments may be made without departing from the spirit and the scope of this invention. Accordingly, it is not the inventor's intention to limit this invention in this application, except as by the claims.

Particular terminology used when describing certain features or aspects of the invention should not be taken to imply that the terminology is being redefined herein to be restricted to any specific characteristics, features, or aspects of the invention with which that terminology is associated. In general, the terms used in the claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise embodiment or form disclosed herein or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

In general, the terms used in the claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

In light of the above “Detailed Description,” Inventor may make changes to the invention. While the detailed description outlines possible embodiments of the invention and discloses the best mode contemplated, no matter how detailed the above appears in text, the invention may be practiced in a myriad of ways. Thus, implementation details may vary considerably while still being encompassed by the spirit of the invention as disclosed by the inventor. As discussed herein, specific terminology used when describing certain features or aspects of the invention should not be taken to imply that the terminology is being redefined herein to be restricted to any specific characteristics, features, or aspects of the invention with which that terminology is associated.

What is claimed is:

1. A dental impression tray comprising:
a center section centered about a longitudinal centerplane, said center section comprising a central base plate, a central outer wall, and a central inner wall concavely curved and terminating at two central end portions;
two side sections, each said side section comprising a side base plate, a side outer wall, and a side inner wall curvedly extending from a side proximal end portion towards a more substantially straight side distal end portion;
two deformation zones, each said deformation zone interconnecting said center section at one of said central end portions and one of said side sections at said side proximal end portion, each said deformation zone for adjusting orientation of one of said side sections relative to orientation of said center section.

2. The dental impression tray of claim 1, wherein said center section further comprises a handle centered about said longitudinal centerplane extending exteriorly from said central base plate proximate to said central outer wall.

3. The dental impression tray of claim 1, wherein said center section further comprises a central inner plate extending from said central inner wall and oriented substantially parallel with said central base plate.

4. The dental impression tray of claim 1, wherein each said side section further comprises a side inner plate extending from one of said side inner walls and oriented substantially parallel with one of said side base plates.

5. The dental impression tray of claim 1, wherein said central outer wall or at least one of said side outer walls further comprise a top lip for securing impression material.

6. The dental impression tray of claim 1, wherein each said side base plate comprises a protrusion for adjusting orientation of each said side section relative to said center section.

7. The dental impression tray of claim 1, further comprising a locking mechanism for securing said side sections in a retracted configuration or an expanded configuration.

8. The dental impression tray of claim 1, wherein said central base plate and said side base plates is porous.

9. The dental impression tray of claim 1, wherein said central base plate extends substantially equivalently or extend further between said central outer wall and said central inner wall at said central end portions than at said longitudinal centerplane.

10. The dental impression tray of claim 7, wherein said locking mechanism comprises a clip positioned on said side outer wall proximate to said side proximal end portion and a latch positioned on said central outer wall proximate to said one of said central end portions.

11. The dental impression tray of claim 10, wherein said latch is a multi-step locking latch for accommodating a variety of dental arch sizes and configurations.

12. The dental impression tray of claim 7, wherein said locking mechanism is releasably detachable for allowing dental impression tray reusability.

13. The dental impression tray of claim 1, wherein said center section or said two side sections are replaceable with one or more widths for accommodating a variety of dental arch sizes and configurations.

14. The dental impression tray of claim 1, wherein said center section or said two side sections are replaceable with one or more heights for accommodating a plurality of facial dental sulcus depths and configurations.

15. The dental impression tray of claim 1, wherein said two side sections are replaceable with one or more lengths for accommodating a variety of dental arch sizes and configurations.

16. The dental impression tray of claim 1, wherein each of said two side sections comprise a beveled, chamfered, rounded or oval cross-sectional profile for accommodating an edentulous dental arch.

17. The dental impression tray of claim 1, wherein at least one of said locking mechanisms is positioned exteriorly on one of said side inner walls and said central inner wall.

18. A dental impression tray comprising:
a center section centered about a longitudinal centerplane, said center section comprising two first hinge ports and the combination of a central base plate, a central outer wall, and a central inner wall concavely curved and terminating at two central end portions;
two side sections, each said side section comprising a second hinge port and the combination of a side base plate, a side outer wall, and a side inner wall curvedly extending from a side proximal end portion towards a more substantially straight side distal end portion;
two hinges, each said hinge interconnecting said center section at one of said first hinge ports with one of said side sections at one of said second hinge ports, wherein said center section and one of said side sections is rotatable about one of said hinges.

19. The dental impression tray of claim 18, wherein said side base plates slide under or over said center base plate while expanding from a retracted configuration to one or more expanded configurations for preventing leakage of impression material.

20. The dental impression tray of claim 18, wherein at least one of said locking mechanisms is positioned between an upper surface of one of said side base plates and a lower surface of said center base plate.
